(19) United States
(12) Patent Application Publication
(10) Pub. No.: US 2012/0020623 A1
(43) Pub. Date: Jan. 26, 2012

(54) FIBER CONNECTOR ASSEMBLY

(75) Inventors: HSIEN-CHU LIN, New Taipei (TW); CHI-NAN LIAO, New Taipei (TW)

(73) Assignee: HON HAI PRECISION INDUSTRY CO., LTD., New Taipei (TW)

(21) Appl. No.: 13/189,552

(22) Filed: Jul. 24, 2011

(30) Foreign Application Priority Data
Jul. 23, 2010 (TW) 99124228

(51) Int. Cl. G02B 6/38

(52) U.S. Cl. 385/58

(57) ABSTRACT

A fiber connector assembly (1000) includes a first fiber connector (100) and a second fiber connector (200). The firs fiber connector (100) comprises a first housing (10) and at least one first fiber (11) combined with the first housing. The second fiber connector (200) comprising a second housing (20), at least one lens (22) mounted to the second insulative housing and a corresponding second fiber (21) optically coupled to the lens. The first fiber is proximate to and aligns with the lens when the first fiber connector mates with the second fiber connector. The first fiber is dimensioned larger than the second fiber.

### FIELD OF THE INVENTION

The present invention generally relates to a connector assembly, and more particularly to a fiber connector assembly for optical signal transmitting.

### DESCRIPTION OF PRIOR ART

Nowadays, optical signal transmitting is widely used for different electronic devices. A fiber connector assembly is an important component for transmitting system. As a fiber has a relative small diameter or dimension, and its end may be mask by dust easily, which may further influence optical signal therethrough. Different method has been considered to eliminate this disadvantage factor.

For example, CN Pub. Pat. No. 101345358 published on Jan. 14, 2009 discloses an optical USB connector assembly which has a fiber device added to a USB connector assembly. The fiber device has a number of fibers connected with lenses embedded in the USB connector. Thus, optical signal transmits along a first fiber and is expanded/magnified by a first lens terminated to the first fiber, and then shrunk by a second lens and runs through second fiber of a complementary connector. However, as the fiber of each connector should be terminated with a corresponding lens, and it takes more manufacturing steps and time to manufacture the connector assembly.

Hence, an improved fiber connector assembly is highly desired to overcome the aforementioned problems.

### SUMMARY OF THE INVENTION

Accordingly, an object of the present invention is to an easily manufactured fiber connector assembly.

In order to achieve the object set forth, a fiber connector assembly in accordance with the present invention comprises a first fiber connector and a second fiber connector. The firs fiber connector comprises a first housing and at least one first fiber combined with the first housing. The second fiber connector comprises a second housing, at least one lens mounted to the second insulative housing and a corresponding second fiber optically coupled to the lens. The first fiber is proximate to and aligns with the lens when the first fiber connector mates with the second fiber connector. The first fiber is dimensioned larger than the second fiber.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first fiber connector and a second fiber connector;

FIG. 2 is similar to FIG. 1, but viewed from other direction;

FIG. 3 shows the first fiber connector mating with a second fiber connector; and

FIG. 4 is a cross section view of FIG. 3 taken along line 4-4.

### DETAILED DESCRIPTION OF PREFERRED EMBODIMENTS

Reference will now be made in detail to the preferred embodiment of the present invention.

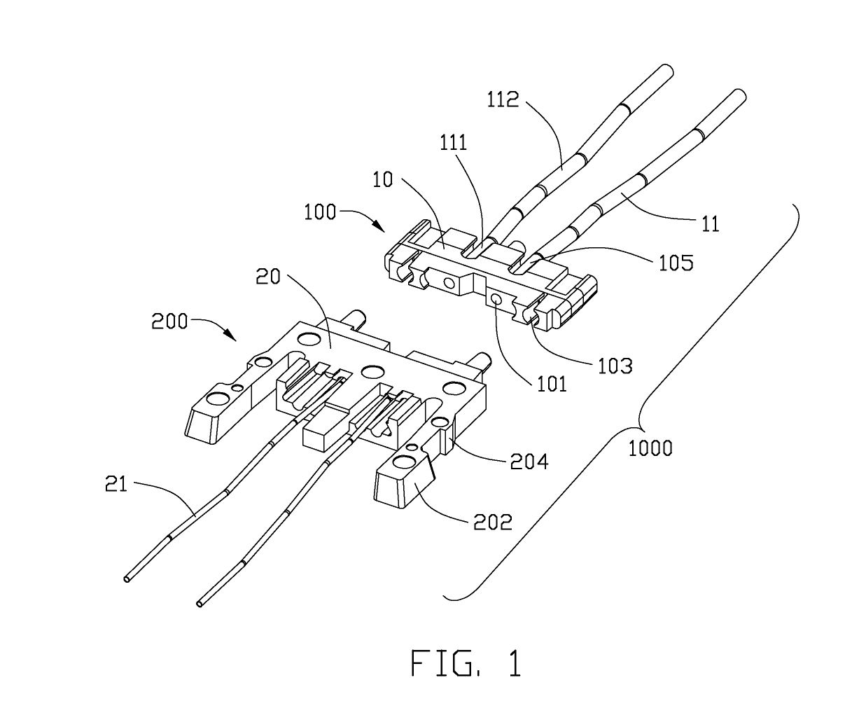

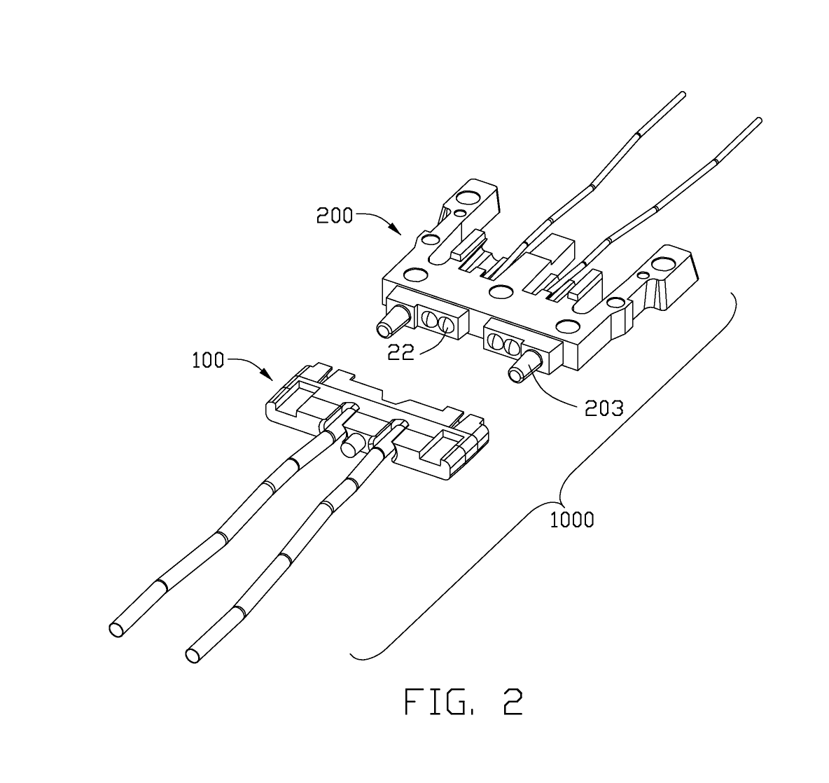

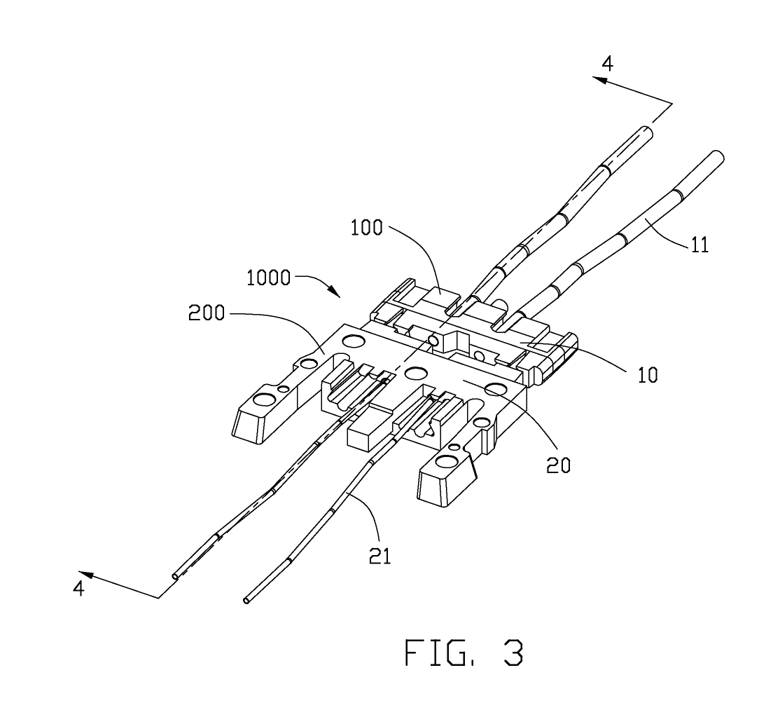

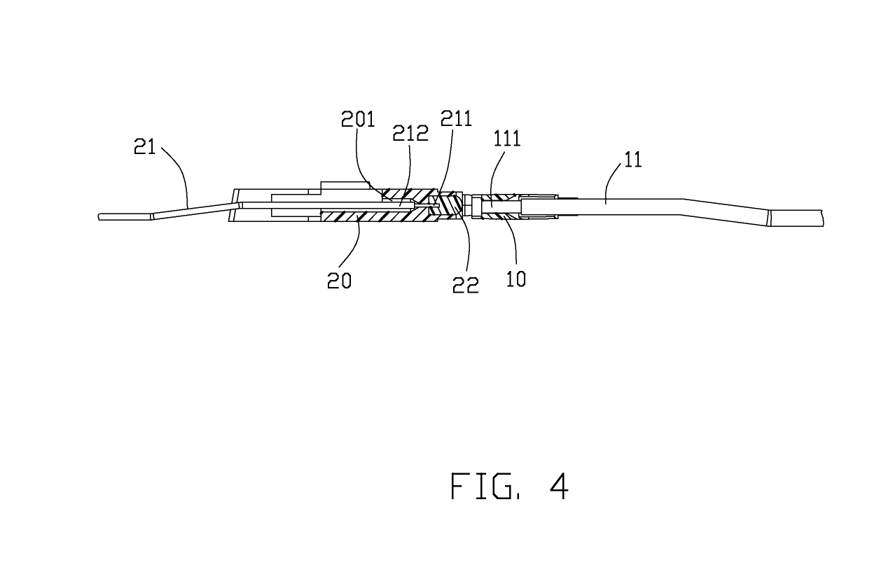

Referring to FIGS. 1-4, a fiber connector assembly 1000 in accordance with the present invention comprises a first fiber connector 100 and a second fiber connector 200.

The first fiber connector 100 includes a first housing 10 and a first fibers 11 combined with the first housing 10.

The first housing 10 defines two first fiber passages 101 extending along a front-to-back direction. The two first fiber passages 101 are spaced apart from each other along a transversal direction perpendicular to the front-to-back direction. In addition, there are two aligning holes 103 recessed backwardly from a front edge of the first housing 10. The two aligning holes 103 are configured to be tapered shaped and further spaced apart from each other along the transversal direction. There is an upper opening 105 located in a back segment of the first housing and disposed above and communicating with a corresponding first fiber passages 101.

The first fiber 11 has a core portion 111 and a shielding portion 112 enclosing the core portion 111. The first fiber 11 is mounted to the first housing 10, with the core portion 111 inserted into and fully matching with the corresponding first fiber passage 101, and a free end of the core portion 111 located proximate to a front opening of the fiber passage 101. In addition, glue or other adhesive material may be applied to the fiber passage 101 via the upper opening 105 to secure the first fiber 11 and the first housing 10.

The second fiber connector 200 includes a second housing 20 and a second fibers 21 combined with the second housing 20. The second housing 20 defines two second fiber passages 201 extending along a front-to-back direction. The two second fiber passages 201 are spaced apart from each other along a transversal direction perpendicular to the front-to-back direction. There are two guiding posts 203 projecting forwardly from a front edge of the second housing 20. The guiding post 203 is of tapered shape and spaced apart each other along the transversal direction. There are two deformable mounting arms 202 extending rearwardly from lateral sections of the second housing 20. In addition, there is a locking tabs 204 formed on outer surface of a front section of the mounting arm 202 and protruding outwardly along the transversal direction.

The second fiber 21 has a core portion 211 and a shielding portion 212 enclosing the core portion 211. There is a lens 22 mounted to/combined with a front segment of the second fiber passage 201. The second fiber 21 is inserted into the second fiber passage 201, with the core portion 211 received in a blind hole (not numbered) of the lens 22 so as to optically coupled to the lens 22. Diameter or dimension of a second fiber 21 is much smaller than diameter/dimension of a first fiber 11. An effective diameter/dimension of the lens 22 for optical signal transmitting is substantially same as the core portion 111 of the first fiber 11, so as to eliminate optical signal transmitting loss between the first fiber connector 100 and the second fiber connector 200.

When the first fiber connector 100 mates with the second fiber connector 200, the guiding posts 203 inserted into the aligning holes 103, respectively. The front end of the first fibers 105 of the first fiber connector 100 is proximate to and aligns with the corresponding lens 22 of the second fiber connector 200. Thus, the optical signal runs along the second fiber 21 and the lens 22, then enters the first fiber 11. It is should be noted that the optical signal may transmits along a reversed direction. The first fiber connector 100 may be inside an electronic device for short distance usage, while the second fiber connector 200 may be used outside of the electronic device for long distance usage.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A fiber connector assembly, comprising:
a first fiber connector comprising a first housing and at least one first fiber combined with the first housing;
a second fiber connector comprising a second housing, at least one lens mounted to the second insulative housing and a corresponding second fiber optically coupled to the lens; and
wherein the first fiber is proximate to and aligns with the lens when the first fiber connector mates with the second fiber connector;
wherein the first fiber is dimensioned larger than the second fiber.

2. The fiber connector assembly as recited in claim 1, wherein the first fiber has a core portion and a shielding portion enclosing the core portion, and the first housing defines a corresponding first fiber passage extending along a front-to-back direction to accommodate the core portion of the first fiber therein.

3. The fiber connector assembly as recited in claim 2, wherein the core portion of the first fiber matches with the first fiber passage.

4. The fiber connector assembly as recited in claim 3, where the core portion of the first fiber has a front end disposed proximate to a front opening of the first fiber passage.

5. The fiber connector assembly as recited in claim 2, wherein the first fiber passage and the core portion are both circular shaped.

6. The fiber connector assembly as recited in claim 2, wherein there is an upper opening located in a back segment of the first housing and disposed above a corresponding first fiber passage.

7. The fiber connector assembly as recited in claim 1, wherein the lens defines a blind hole to receive a core portion of the second fiber.

8. The fiber connector assembly as recited in claim 1, wherein there are two aligning holes defined in the first housing to receive two guiding posts of the second housing.

9. A fiber connector assembly, comprising:
a first fiber connector comprising a first housing and at least one first fiber combined with the first housing;
a second fiber connector comprising a second housing, at least one lens combined with the second insulative housing and a corresponding second fiber optically coupled to the lens; and
wherein the first fiber aligns with the lens when the first fiber connector mates with the second fiber connector;
wherein the first fiber has a diameter larger than the second fiber's.

10. The fiber connector assembly as recited in claim 9, wherein the first fiber connector has two of the first fibers respectively extending into two first fiber passages defined in the first insulative housing.

11. The fiber connector assembly as recited in claim 10, wherein the second fiber connector has two of the second fibers optically coupled to two of the lenses, respectively.

12. The fiber connector assembly as recited in claim 9, wherein there are two of the lenses spaced apart from each other along a transversal direction.

13. The fiber connector assembly as recited in claim 9, wherein the lens having an effective diameter for optical signal transmitting is substantially same as a diameter of a core portion of the first fiber.

14. The fiber connector assembly as recited in claim 9, wherein the first fiber connector has two aligning holes recessed backwardly from a front edge of the first housing, and the second connector has two guiding posts projecting forwardly from a front edge of the second housing.

15. The fiber connector assembly as recited in claim 14, wherein both the aligning holes and the guiding posts are tapered shape.

16. The fiber connector assembly as recited in claim 9, wherein there are two deformable mounting arms extending rearwardly from lateral sections of the second housing.

17. The fiber connector assembly as recited in claim 16, wherein there is a locking tab formed on outer surface of each deformable mounting arm.

18. A method of light transmission between two items, comprising steps of:
providing a first optical connector with a first optical fiber having a smaller diameter thereof;
providing a second optical connector with a second optical fiber having a larger diameter thereof; and
providing a lens at an interface between the first optical connector and the second optical connector; wherein
said lens defines two opposite faces, of which on one face a transmitted light beam in the lens defines a converging end confronting the first optical fiber, and on the other face a diverging end confronting the second optical fiber.

19. The method of light transmission as claimed in claim 18, wherein the lens is equipped with the first optical connector.

20. The method of light transmission as claimed in claim 118, wherein the first optical fiber intimately contacts the face of the lens while the second optical fiber are spaced from the other face of the lens with a tiny gap therebetween.
